(19) United States
(12) Patent Application Publication
(10) Pub. No.: US 2011/0032311 A1
(43) Pub. Date: Feb. 10, 2011

(54) INKJET PRINT HEAD AND METHOD OF MANUFACTURE THEREFOR

(75) Inventor: Toshio Miyazawa, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: Toshiba Tec Kabushiki Kaisha, Tokyo (JP)

(21) Appl. No.: 12/848,912

(22) Filed: Aug. 2, 2010

(30) Foreign Application Priority Data
Aug. 7, 2009 (JP) 2009-184256

(51) Int. Cl. B41J 2/045; B23P 17/00

(52) U.S. Cl. 347/71; 29/890.1

(57) ABSTRACT

According to one embodiment, there is formed a sidewall that isolates pressure chambers and is provided with an oblique angle on its ends in the ink flow direction; an electrode provided on the sidewall and a wiring part are connected; a substrate and an piezoelectric material are adhered together using an adhesive; the piezoel ectric material is processed to form grooves therein; then, a metal film making an electrode and a wiring part is formed on the sidewall and substrate; then, a non-wiring part is formed on the substrate and the piezoelectric material by laser light as a first processing method; subsequently, a non-wiring part is formed on the adhesive portion by a second processing method different from the first method. Thus, widths of the electrode and the wiring connected to an actuator can be uniformized thereby to reduce the variation among voltages applied to the individual actuators.

This application is based upon and claims the benefit of priority from the prior Japanese Patent Applications No. 2009-184256 filed on Aug. 7, 2009, the contents of which are incorporated herein by reference.

### TECHNICAL FIELD

This disclosure relates to an inkjet printhead forming an image by ejecting ink droplets. The disclosure also relates to a method of manufacturing the inkjet print head.

### BACKGROUND

U.S. patent application publication No. 2002/0008741 (Jpn. Kohyo No. 2002-529289) discloses a so-called “Shear-mode type inkjet printhead” that ejects inks from nozzles using shear-mode deformation of piezoelectric electric members.

The inkjet printhead disclosed in the publication has pressure chambers that each are sandwiched by post members formed by plural piezoelectric materials in a room surrounded by a substrate and a nozzle plate. The substrate is provided with an ink supply port. An electrode of a metal film of a conductive material is provided on the surface of the post members. Ink is introduced from the ink supply port to the inkjet printhead, and is ejected from a nozzle through the pressure chamber.

After the formation of the films, non-wiring part is formed by removing a metal film in the areas other than the wiring part. The non-wiring part is formed along the longitudinal direction of the top of the post member using laser beams.

To form the non-wiring part, a metal film in the part other than the wiring part needs to be removed in addition to removal of the metal film formed on the pressure chamber. At the end portions of the post member in the boundary between the post member and the substrate, a slant is provided in the longitudinal direction of the post member. The publication describes that the slant angle is desirably at 45 degrees.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a view showing a skeleton framework of an inkjet printhead in the present embodiment.

FIG. 2 shows a nozzle plate and ink channels.

FIG. 3 shows the inkjet printhead in the present embodiment viewed from an ink ejecting direction.

FIG. 4 is a sectional view of the inkjet printhead in the present embodiment.

FIG. 5 is a sectional view of the inkjet printhead in the present embodiment.

FIG. 6 shows movable parts of an inkjet recording device.

FIG. 7 shows a process of manufacture in a first embodiment.

FIG. 8 shows a process of manufacture in the first embodiment.

FIG. 9 shows a process of manufacture in a second embodiment.

FIG. 10 shows a process of manufacture in the second embodiment.

FIG. 11 shows a process of manufacture in a third embodiment.

FIG. 12 shows a process of manufacture in the third embodiment.

FIG. 13 shows a process of manufacture in a fourth embodiment.

FIG. 14 shows a process of manufacture in the fourth embodiment.

FIG. 15 shows a process of manufacture in the fourth embodiment.

### DETAILED DESCRIPTION

According one embodiment of the present application, there is provided an inkjet printhead, which comprises: a substrate; actuators for varying a volume of a pressure chamber, each actuator having an obliquity angle at their ends in an ink flow direction within the pressure chamber and forming a sidewall that isolate the respective pressure chambers, and composing of a piezoelectric material; an adhesive layer for fixing the actuators to the substrate; an electrode composing of a metal film provided on the sidewall; a wiring part composing of the metal film connected to the electrode; a connecting part composed of the metal film, formed on the adhesive layer, for connecting the electrode and the wiring part; a first non-wiring part provided between electrodes formed on the adjacent sidewalls and between the adjacent wiring parts; and a second non-wiring part formed between the adjacent connecting parts in a method different from the method of forming the first non-wiring part.

According another embodiment of the present application, there is provided a method of manufacture of an inkjet printhead which comprises a substrate, actuators varying a volume of a pressure chamber, each actuator composing of a piezoelectric material, being adhered to the substrate and having an oblique angle at their ends in an ink flow direction within the pressure chamber, each actuator forming a sidewall that isolate the respective pressure chambers, an electrode composing of a metal film provided on the sidewall, a wiring part connected to the electrode, and a non-wiring part provided between the adjacent wiring parts, the method comprising: adhering a substrate and an piezoelectric material together using an adhesive; processing the piezoelectric material to form a groove therein; forming a metal film on the sidewall and the substrate, the metal film as being the electrode and the wiring part; forming a non-wiring part on the substrate and the piezoelectric material by a first processing method; and forming a non-wiring part on the adhesive part by a second processing method different from the first processing method.

To form an electrode and wiring of an inkjet printhead incorporating shear-mode deformation of a piezoelectric material, if, after a metal film is formed in overall area including the electrode and wiring, unwanted parts are removed by emitting laser light on the parts, the following phenomenon occurs.

In a process of forming an inkjet printhead, electrodes, wiring part, and non-wiring part are formed by first adhering a piezoelectric material to a substrate using an adhesive, processing the piezoelectric material to form grooves thereon, providing a metal film on the surface where electrodes and wirings are to be formed and applying laser light from the piezoelectric material to the substrate. In this case, when the metal film on the adhesive between the piezoelectric material and substrate is removed by the laser light, the metal film part over the adhesive ends up getting processed larger than the width of the laser light. The reason for this is considered due to large differences in thermal conductance and thermal expansion coefficient between the adhesive (resin), substrate (ceramic), and piezoelectric material.

Due to the dimensional variation of the metal film removing part in the adhesive area, the formation of an accurate width of the non-wiring part using laser processing is difficult. In some cases, the width of the non-wiring part ends up extending to a neighboring non-wiring part. If this occurs, the wiring to apply a drive voltage to the relative actuator becomes disconnected disabling the function of the related pressure chamber.

In an inkjet printhead incorporating high-density nozzles, intervals between nozzles and between post members are narrow. As the interval between the post members becomes narrow, the interval between the non-wiring parts also becomes narrow. As a result, the width of the wiring becomes narrow. This narrowed wiring width increases a risk of disconnection by laser processing in the wiring part over the adhesive.

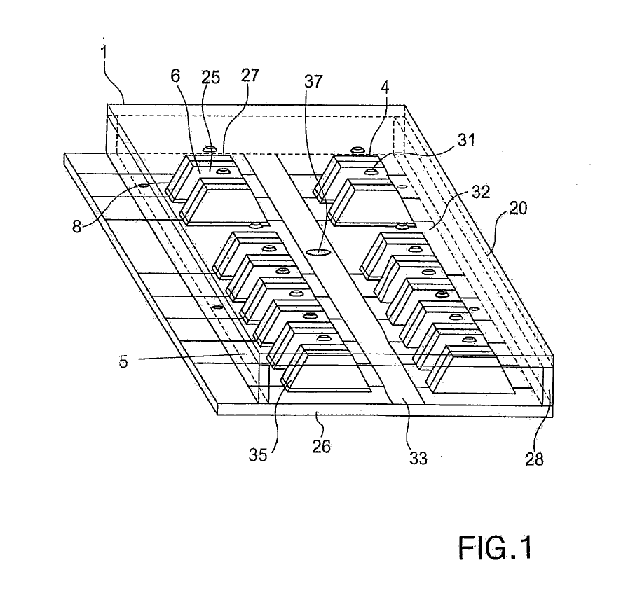

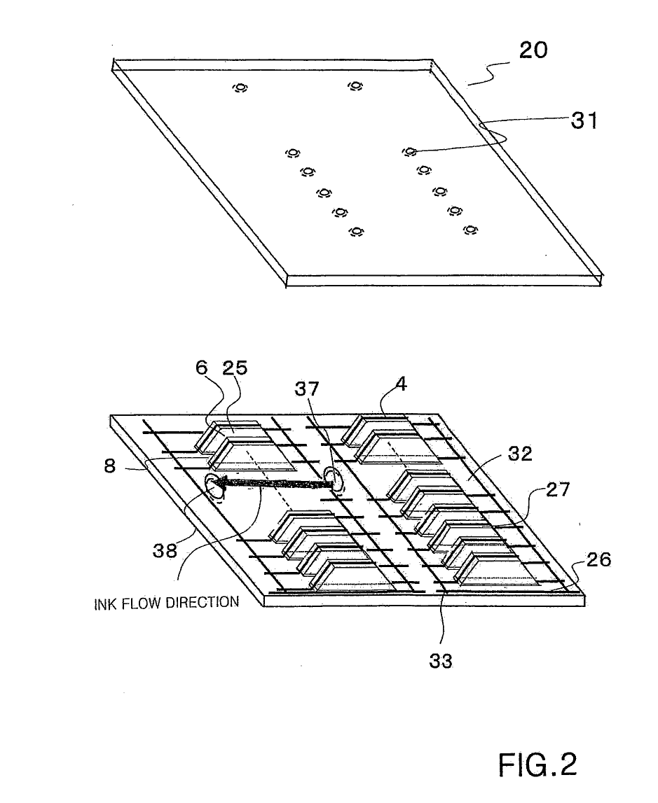

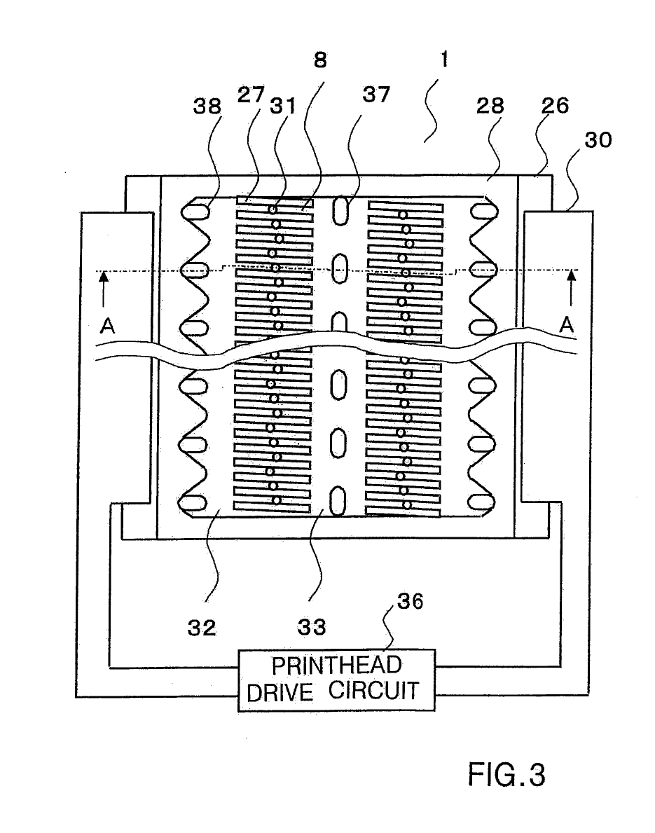

FIG. 1 shows a whole structure of an inkjet printhead 1. FIG. 2 shows a nozzle plate and a pressure chamber divided into two parts. FIG. 3 is a view of inkjet printhead 1 viewed from the ink ejection direction, showing an interior of inkjet printhead 1 seeing through a nozzle plate 20.

In reference to FIG. 1, the structure of inkjet printhead 1 will be described below. Inkjet printhead 1 is comprised of a nozzle plate 20, an actuator 27, a substrate 26, and a frame member 28. There are formed multiple nozzles 31 for ejecting ink in nozzle plate 20. Each of nozzles 31 is formed such that its opening towards a pressure chamber 8 is larger than the opening of the outer ink ejection side. Actuators 27 eject an ink droplet from nozzle 31 by changing the volume of pressure chamber 8 surrounded by nozzle plate 20, substrate 26, and actuators 27. There are formed in substrate 26 an ink-ink-supply-side substrate hole 37 and an ink-discharge-side substrate hole 38. There are formed an ink-supply-side common pressure chamber 33 and an ink-discharge-side common pressure chamber 32 inside a room formed and sealed by nozzle plate 20 and substrate 26 with actuators 27 and frame member 28 interposed therebetween. The one ends of the multiple pressure chambers 8 are connected to ink-supply-side common pressure chamber 33, and the other ends of the chamber 33 are connected to ink-discharge-side common pressure chambers 32. This inkjet printhead 1 is provided with two lines of the pressure chambers. Provided between the two lines of the chambers are ink-supply-side common pressure chamber 33, and ink-discharge-side common pressure chambers 32 on the both outer sides of the chamber lines.

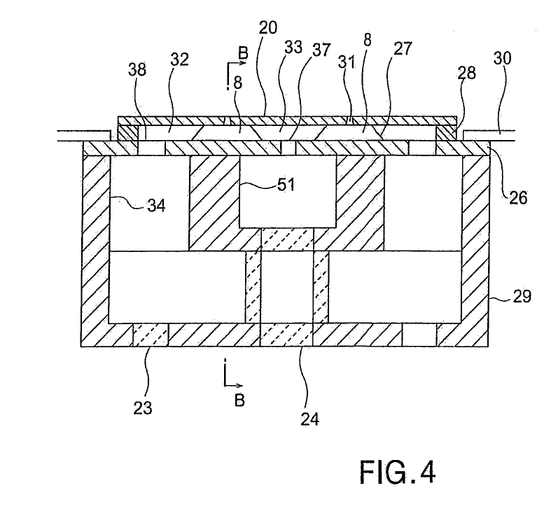

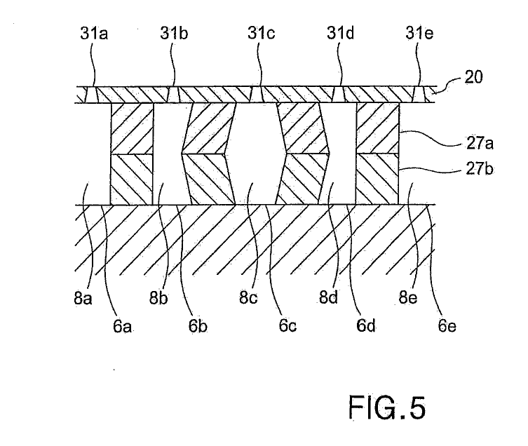

Inkjet printhead 1 is connected to a printhead drive circuit 36 through a printed flexible cable 30, as shown in FIG. 3. FIG. 4 is a sectional view taken along the line A-A in FIG. 3. FIG. 5 is a sectional view taken along the line B-B in FIG. 4. A rear cover 29 is provided with an ink supply groove 51 having an ink supply port 24 and an ink discharge groove 34 having an ink discharge port 23, and is adhered to a side of substrate 26 opposite the side where pressure chamber 8 is provided. Printed flexible cable 30 is provided to supply a drive signal that drives inkjet printhead 1 from a printhead drive circuit 36 to an actuator 27.

The ink flows in the sequence of an ink supply port 24, an ink supply groove 51, ink-supply-side substrate hole 37, ink-supply-side common pressure chamber 33, pressure chamber 8, ink-discharge-side common pressure chamber 32, ink-discharge-side substrate hole 38, ink discharge groove 34, ink discharge port 23. This pathway constitutes an ink circulation pathway. Ink induced into pressure chamber 8 is pressurized by the actuators thereby to be ejected from the nozzle. Ink that is not ejected passes through the ink circulation pathway and is supplied from ink supply port 24 again.

Actuator 27 deforms in shear-mode by voltages being applied to electrodes 6 provided on the both sides of the piezoelectric material. The piezoelectric material constituting actuator 27 is fixed to substrate 26 with an adhesive. There is formed an electrically independent electrode 6 on the internal surface of each of plural pressure chambers 8 that are formed between actuators 27, and electrode 6 is electrically connected to printed flexible cable 30 through a wiring section 5. Electrode 6 is a metal film formed on the internal surface of pressure chamber 8 of a sidewall 25 of piezoelectric material 2 to operate actuator 27. Wiring section 5 is a part of a metal film formed to electrically connect electrode 6 to printed flexible cable 30. A non-wiring part refers to a part excluding wiring section 5 and electrode 6 where a metal film is not formed or removed. An insulation film is formed on the surfaces of electrode 6 and the wiring section of substrate 26 except the connection part to printed flexible cable 30 to prevent electricity flow from electrode 6 to the ink. Actuator 27 is composed of piezoelectric elements 27a and 27b having polarity directions opposite to each other, and deforms in shear-mode thereby to vary the volume of pressure chamber 8 when an electric field is applied in the direction orthogonal to its polarity direction. For example, as illustrated in FIG. 5, if a high voltage is applied to an electrode 6C while a low voltage is applied to electrodes 6b and 6d, the volume of a pressure chamber 8c expands. On the contrary, if a low voltage is applied to electrode 6c and a high voltage to electrodes 6b and 6d, the volume of pressure chamber 8c decreases.

Specific dimensions of the actuator are as follows. The width of actuator 27 is 80 μm and the height is 600 μm. Interval between actuators 27 is 169 μm. The length the actuator in its longitudinal direction is 2.5 mm. The both end parts of the actuator in its longitudinal direction form slants. The slant is at 45 degrees relative to substrate 26. Nozzles forming one line shift by 84 μm relative to ones forming other line. Naturally, the width of and interval between actuators 27 vary depending on a resolution required to inkjet printhead 1, and the length and height of the printhead vary depending upon the amount of ink ejected to be required.

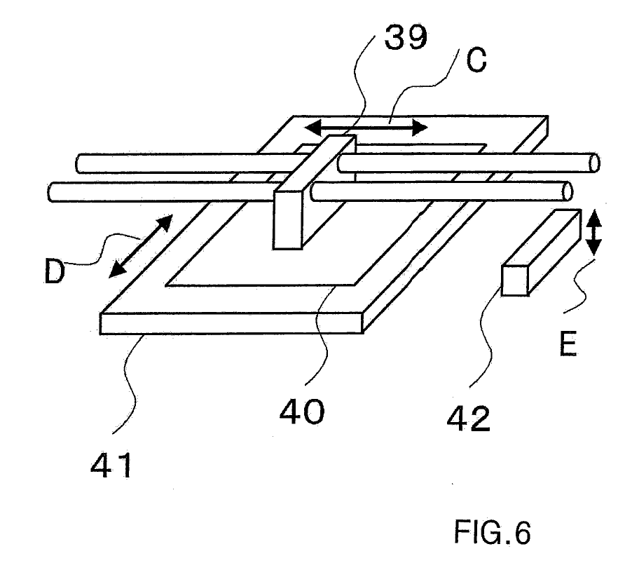

FIG. 6 shows a structure of an inkjet recording apparatus. A carriage 39 mounting inkjet printhead 1 moves sideways as shown by arrow C. A table 41 holding a recording medium 40 moves in the depth direction by arrow D. A nozzle cap 42 incorporating a well-known ink-sucking means moves vertically in the arrow E direction. Inkjet printhead 1 performs printing by operating main-scanning (in the C direction) by the movement of carriage 39 and sub-scanning (in the D direction) by the movement of table 41. During the pause of printing, carriage 39 removes to the right end and nozzle cap 42 upwards to prevent the solvent within the ink from being evaporated.

Nozzle plate 20 is a polyimide film having a thickness of 50 μm. There are formed multiple nozzles 31 in line, each of which corresponds to individual pressure chamber 8. In inkjet printhead 1, there are formed nozzles corresponding to all of pressure chambers 8 disposed in two lines. The diameter of the individual nozzles on its ink ejection side is 30 μm, while the diameter on the ink chamber side is 50 μm. The nozzle plate may be formed as a metal plate using nickel, silicon, etc. instead of polyimide. The diameter of the nozzle is determined by a quantity of ejected ink required.

Considering differences on their expansion coefficient and dielectric constant between substrate 26 and piezoelectric material 2, a PZT having a low dielectric constant is used for substrate 26. For substrate 26, alminum (Al₂O₃), silicon nitride (Si₃N₄), silicon carbide (SiC), aluminum nitride (AlN), lead zirconate titanate (PZT), etc. may be used.

Materials suitable to use for piezoelectric material 2 are lead zirconate titanate (PZT: Pb(Zr, Ti)O₃), lithium niobate (LiNbO₃), lithium tantalite (LiTaO₃), etc. In this embodiment, a PZT having a higher piezoelectric constant is used.

Electrode 6 is formed of nickel. The film thickness of electrode 6 is 2 μm. This electrode 6 is formed over the surface of actuator 27 by the electroless nickel plating technique. Although this embodiment uses the electroless nickel plating technique, the plating method need not be restricted to this. Electrode 6 may be also formed of gold and copper. The method of forming a film of electrode 6 besides the electroless nickel plating technique include the radio frequency magnetron sputtering method, ion-beam sputtering method, chemical-vapor-deposition method (CVD method), EB method (Electron Beam Co-deposition method), etc.

Actuator 27 is composed of a first piezoelectric element 27a and a second piezoelectric element 27b. Actuator 27a is adhered to second piezoelectric element 27b so that polarization directions of the two elements oppose each other. First piezoelectric element 27a and second piezoelectric element 27b are formed of piezoelectric material of PZTs (lead zirconate titanate).

There are connected to inkjet printhead 1 a printhead drive circuit 36 for driving the printhead, a cable extending to a control section provided in inkjet printhead 1, a power cable extending to a power supply.

To perform printing using the inkjet printer having the above-described inkjet printhead 1, ink needs to be filled in advance in pressure chamber 8 of inkjet printhead 1. When a user instructs print to the inkjet printer in a state that the ink is supplied through ink supply port 24, the controller outputs a print signal to a printhead drive circuit 36 of inkjet printhead 1 through the signal cable. Printhead drive circuit 36 received the print signal applies a drive pulse voltage to an actuator 27.

Then, a pair of the right and left actuators 27 of cooperating piezoelectric elements 27a, 27b deform being bent by the shear-mode strain. The volume of pressure chamber 8 expands once by an S1 signal, then contracts to pressurize the ink in pressure chamber 8 so that an ink droplet is vividly ejected from the nozzle 31. Thereafter, actuator 27 returns to the initial state.

Hereinafter, first to fourth embodiments will be described referring to the drawings. Shown in the left view are front views, and in the right A-A and B-B sectional views corresponding to the respective front views.

“Laser processing” referred herein is one to form a non-wiring part. A laser processing machine incorporating a galvano-optical unit and having a spot diameter of 40 μm was used.

### First Embodiment

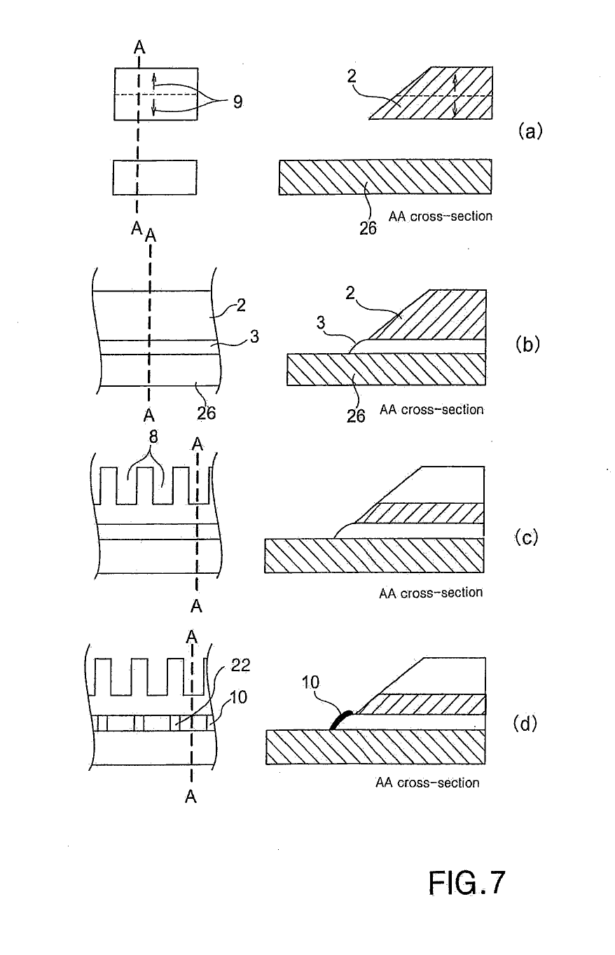

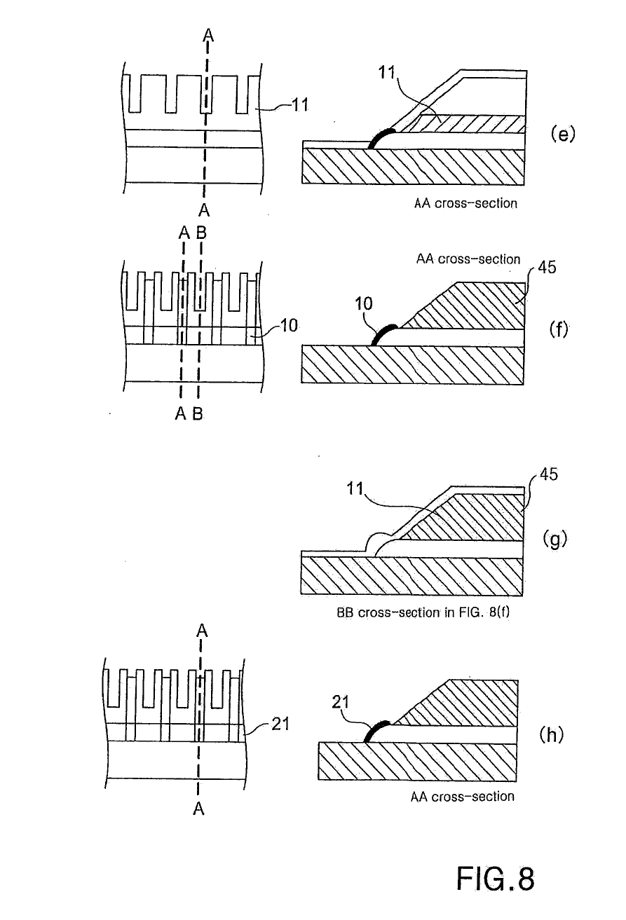

First, a first embodiment will be described. FIGS. 7 and 8 illustrate process flows in the first embodiment. FIGS. 7 and 8 indicate end portions of the actuator formed with piezoelectric material 2. FIG. 7(a) shows piezoelectric material 2 and substrate 26. Piezoelectric material 2 is formed by bonding two sheets of PZT together having polarization directions 9 opposed to each other. Herein, a PZT material of 200 μm in thickness is adhered onto another PZT material of 400 μm in thickness. A slant is provided in the end portions of piezoelectric material 2 thus formed. The slant is formed by cutting the ends of piezoelectric material 2 using a grindstone of diamond, etc.

FIG. 7(b) shows a state in which the above-mentioned bonding piezoelectric material 2 is adhered to substrate 26 by an adhesive 3. Adhesive 3 is an epoxy agent. Adhesive 3 is thinly coated over the surface of piezoelectric material 2 facing substrate 26, with the piezoelectric material 2 positioned and pressurized towards substrate 26. Then, the adhesive was thermally cured at 150° C. with the pressure being held. Adhesive 3 runs out arcuately a little because of the pressurization during the bonding. The thickness of the adhesive layer is specified to be some 10 μm.

FIG. 7(c) shows a state after the grooves were formed. The grooves (pressure chambers 8) are formed in piezoelectric material 2 by cutting work with a diamond blade. The cutting work was performed setting the groove width to 80 μm, groove depth to 400 μm and, groove interval between grooves to 169 μm.

FIG. 7(d) shows a state in which a resist 10 was formed on adhesive 3. Resist 10, which uses a photosensitive material, was provided on adhesive 3 that adheres substrate 26 and piezoelectric material 2 together where a non-wiring part 22 (second non-wiring part) is formed. Resist 10 may be formed not only adhesive 3, but also covering the non-wiring parts of piezoelectric material 2 and substrate 26 including adhesive 3. By forming photosensitive resist 10 covering piezoelectric material 2, adhesive 3, and substrate 26, remaining of a metal film within the non-wiring parts in the boundaries between piezoelectric material 2 and adhesive 3 and between substrate 26 and adhesive 3 can be prevented.

FIG. 8(e) shows a state in which a Ni metal film 11 was formed on the upper surface of substrate 26 and surface of piezoelectric material 2 by the electroless nickel plating.

Thereafter, by emitting laser light, metal film 11 is removed and non-wiring part 22 (first non-wiring part) is formed. Electrodes are formed on the piezoelectric material. FIG. 8(f) is an A-A cross-sectional view taken along the portion where the laser processing has been applied. FIG. 8(g) is a B-B cross-sectional view when the part between post members 45 of the pressure chamber is cut. FIG. 8(f) is the A-A cross-sectional view and FIG. 8(g) is the B-B cross-sectional view, when resist 10 is formed on non-wiring part 22 over adhesive 3, respectively. This laser light is applied to the top of actuator 27 in the longitudinal direction, a slant 35, and substrate 26. The width of a metal-film-removed-part 4 is 40 μm, and accordingly the width of the non-wiring part becomes 40 μm. The laser processing is not applied onto resist 10 on adhesive 3. By applying the laser light over substrate 26, a non-wiring part can be provided between the wiring parts.

The electroless nickel plating is not formed over resist 10. That is, by cutting out the metal film on the surfaces of substrate 26 and piezoelectric material 2 by the laser processing, that is a first processing method, a non-wiring part is provided. Then, by removing resist 10, another non-wiring part (second non-wiring part) is provided. FIG. 8(h) shows a state in which resist 10 has been removed. In this state, the process for the wiring is completed. After the resist (second non-wiring part) is removed, a partial metal pattern remains on the adhesive. This metal pattern on the adhesive electrically connects the electrode with the wiring part.

### Second Embodiment

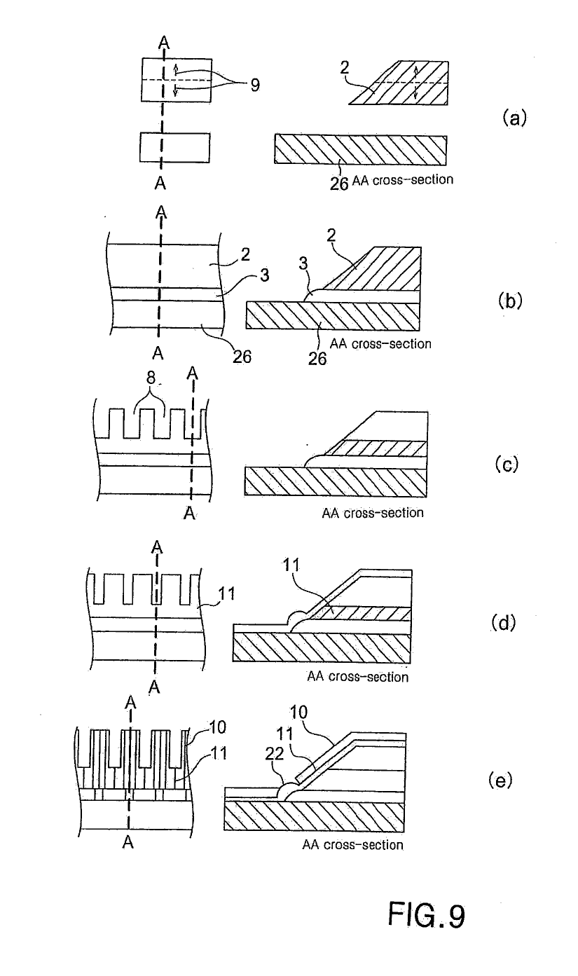

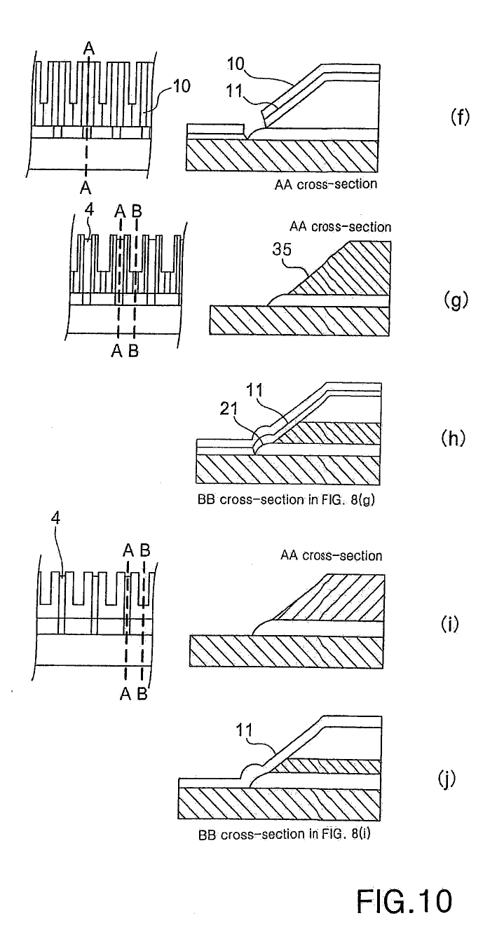

Now, a second embodiment will be described. FIGS. 9 and 10 illustrate process flows in the second embodiment. FIG. 9(a) shows piezoelectric material 2 and substrate 26. Piezoelectric material 2 is formed by bonding two sheets of a PZT, together, having polarization 9 directions opposed to each other. Herein, a PZT material of 200 μm thick is adhered onto another PZT material of 400 μm thick. A slant is provided in the end portions of piezoelectric material 2 thus formed by the cutting work using a grindstone of diamond, etc.

FIG. 9(b) shows a state in which the bonding piezoelectric material 2 is adhered to substrate 26 by an adhesive 3. Adhesive 3 is an epoxy agent. Adhesive 3 runs out arcuately a little because of the pressurization applied during the bonding. The thickness of the adhesive is specified to be some 10 μm. The curvature radius in the arcuate portion where the adhesive 3 runs out is specified to be some 10 μm.

FIG. 9(c) shows a state in which grooves (pressure chambers) 8 were formed along the ink flow direction. The grooves are formed by cutting work with a diamond blade. The cutting work is performed setting the groove width to 80 μm, groove depth to 400 μm, and groove interval between grooves to 169 μm.

FIG. 9(d) shows a state in which a metal film 11 is formed on the upper surface of the substrate and surface of piezoelectric material 2 in which grooves are formed. Metal film 11 is formed by the electroless plating technique on the surface of piezoelectric material 2 and the surface to which piezoelectric material 2 of substrate 26 is adhered.

Resist 10 is formed on the film portion of metal film 11. At this time, for this resist 10 a photosensitive material is used. Among the part on adhesive 3 where metal film 11 is formed, only resist 10 in the portion constituting non-wiring part 22 is removed. FIG. 9(e) shows the resist-removed-part. Metal film 11 is removed by the wet etching technique. The dry etching technique can be employed instead of the wet etching technique. FIG. 9(f) shows a structure in which metal film 11 is etched. Metal film 11 in the portion where resist 10 has been removed is removed by the etching.

Resist 10 is removed. FIGS. 10(i) and 10(j) show a state after resist 10 has been removed. Resist 10 formed totally except the non-wiring part on the adhesive was removed using a resist liquid solution. This completes the formation of the wiring part.

FIGS. 10(g) and 10(h) shows a state in which a non-wiring part 22 was formed. Laser light is applied to the portion of non-wiring part 22 excluding the bonding part. The laser light is applied onto the top part of actuator 27 in the longitudinal direction except the non-wiring part over the bonding part, a slant 35, and substrate 26. The width of metal-film-removed-part 4 by laser light is 40 μm.

### Third Embodiment

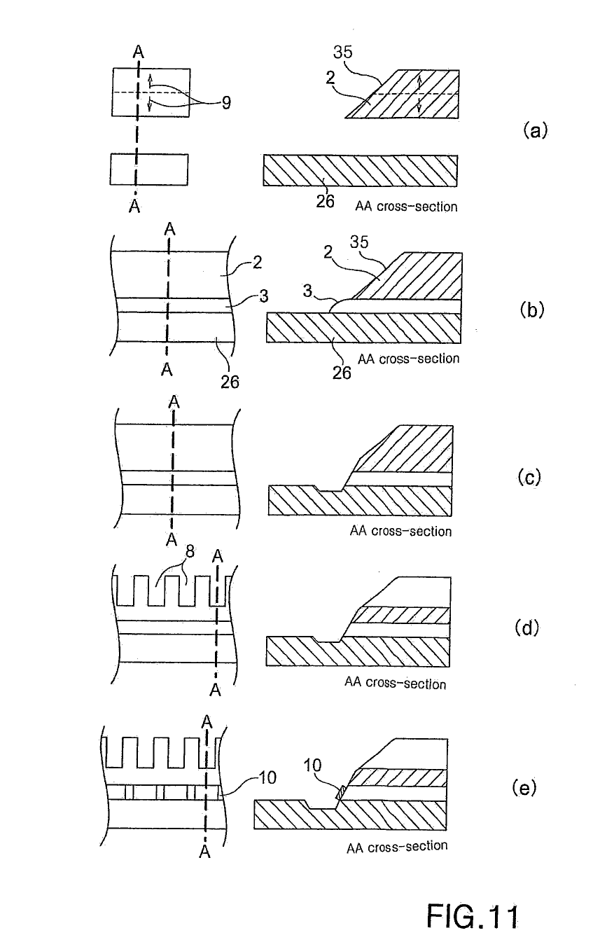

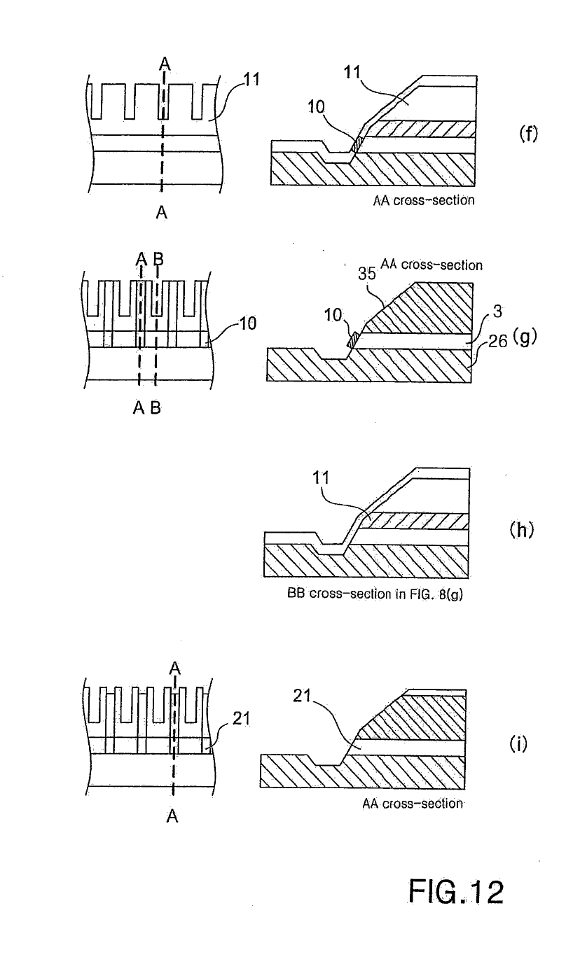

Consecutively, a third embodiment will be described. FIGS. 11 and 12 show process flows in the third embodiment. FIG. 11(a) shows piezoelectric material 2 and substrate 26 before being adhered. Piezoelectric material 2 and substrate 26 are adhered using an adhesive. Piezoelectric material 2 is formed by adhering together two PZTs having opposite polarization directions 9 to each other. Herein, a PZT of 200 μm thick is adhered to a PZT of 400 μm thick. A slant 35 is provided to thus formed piezoelectric material 2. The formation process of this slant is identical to that of the second embodiment.

The slant formed in the end portions of piezoelectric material 2 is inclined at a first angle (45° C.) with respect to substrate 26. FIG. 11(b) shows a state in which piezoelectric material 2 is adhered to substrate 26 using adhesive 3. Adhesive 3 uses an epoxy adhesive. Adhesive 3 runs out arcuately a little because of the pressurization applied during the adhesion.

To smooth out the run-out adhesive 3, a slant of a second angle different from the slant angle (first angle) of the end portion in the ink flow direction within pressure chamber 8 is formed in a direction orthogonal to the ink flow direction. The second slant angle is cut out in the end portion of piezoelectric material 2, adhesive 3, and adhesive 3 between substrate 26 and piezoelectric material 2. The second slant is formed by cutting with a diamond blade.

FIG. 11(d) shows a state after the cutting work of the groove, in which the grooves (pressure chambers) 8 are formed by a diamond blade. The cutting work is performed setting the groove width to 80 μm, the groove interval between grooves to 169 μm, and groove depth to 400 μm.

FIG. 11(e) shows a resist pattern of a non-wiring part. Resist 10 is formed in the part of adhesive 3 between substrate 26 and piezoelectric material 2 which becomes a first non-wiring part 22. For this resist 10, a photosensitive material is used. This resist pattern is provided by first forming a uniform resist film over piezoelectric material 2, substrate 26, and adhesive 3, and then emitting ultraviolet light through a mask pattern forming a non-wiring part to remove the remaining part excluding the non-wiring part of the resist.

FIG. 12(f) shows a state in which Ni metal film 11 was formed on the upper surface of substrate 26 and the surface of piezoelectric material 2 by the electroless plating technique.

FIG. 12(g) is an A-A cross-sectional view of FIG. 12(f) along the laser-processed portion. FIG. 12(h) is a B-B cross-sectional view along the portion that divides the bottom of the pressure chamber into halves. The second non-wiring part 22 is formed on substrate 26 and actuator 27 by removing metal film 11 excluding the portion of resist 10 over adhesive 3 by the laser light emission. This laser light is applied to the top part of actuator 27 in its longitudinal direction, slant 35, the portion of adhesive 3, and substrate 26. The width metal-film-removed-part 4 by the laser light is 40 μm.

FIG. 12(i) shows a state after resist 10 has been removed. The resist 10 is removed, and the non-wiring parts on actuator 27, adhesive 3, and substrate 26 divides the wiring part connected to electrode 6 into the respective two parts. Thus, electrode 6 and wiring section 5 can be provided for each pressure chamber.

### Fourth Embodiment

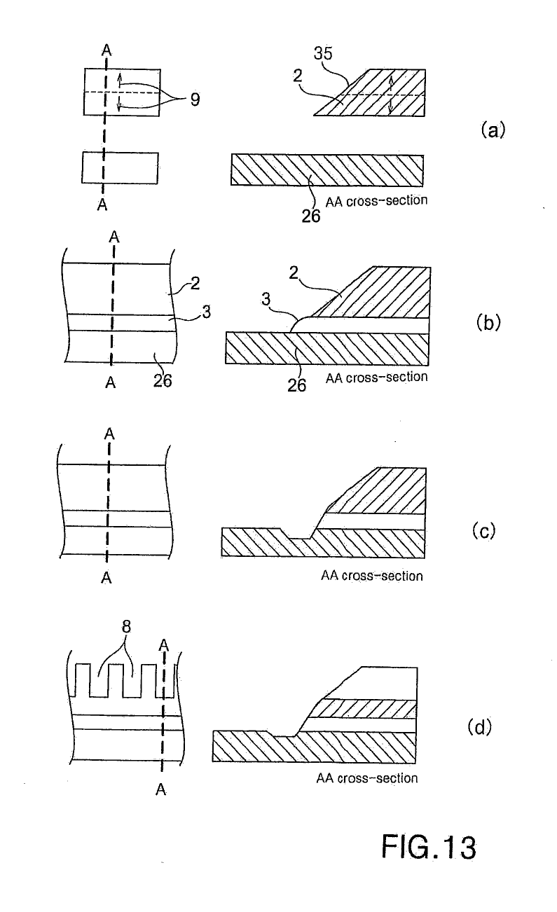

Consecutively, a fourth embodiment will be described. FIGS. 13, 14, and 15 show process flows of the fourth embodiment. FIG. 13(a) shows piezoelectric material 2 and substrate 26 before they are adhered together using an adhesive. Piezoelectric material 2 and substrate 26 are adhered together using an adhesive. Piezoelectric material 2 is formed by adhering two PZTs having opposite polarization directions 9 to each other. Herein, a PZT of 200 μm thick is adhered to a PZT of 400 μm thick. Slant 35 is provided to thus formed piezoelectric material 2. The formation of the slant is identical to that in the second embodiment.

By providing the second slant having an angle different from one of the first slant, the portion of the run-out adhesive 3 can be formed linearly preventing its arcuate formation. If adhesive 3 is formed arcuately, Ni metal film 11 tends to remain in the boundary between adhesive 3 and piezoelectric material 2, and boundary between adhesive 3 and substrate 26. By forming the adhesive portion linearly, accurate formation of the non-wiring parts can be made even in the boundaries between piezoelectric material 2 and adhesive 3, and adhesive 3 and the substrate. As a result, the widths of the wirings can be formed more uniformly.

Then, piezoelectric material 2 is adhered to substrate 26 with an adhesive. FIG. 13(b) shows a state after piezoelectric material 2 and substitute 26 were adhered together. Adhesive 3 is an epoxy agent. Adhesive 3 runs out arcuately a little because of the pressurization applied during the adhesion process.

To smooth out the run-out adhesive 3, a slant of a second angle different from the slant angle (first angle) of the end portions in the ink flow direction within pressure chamber 8 is formed in a direction orthogonal to the ink flow direction. The second slant angle is cut out in the end portions of piezoelectric material 2, adhesive 3, and adhesive 3 between substrate 26 and piezoelectric material 2. The second slant is formed by cutting work with a diamond blade at the same time when the grooves are formed in substrate 26.

FIG. 13(d) shows a state in a state in which the grooves (pressure chamber) 8 were formed along the ink flow direction. The grooves are formed by cutting work by a diamond blade. The cutting work is performed setting the groove width to 80 μm, the groove interval between grooves to 169 μm, and groove depth to 400 μm.

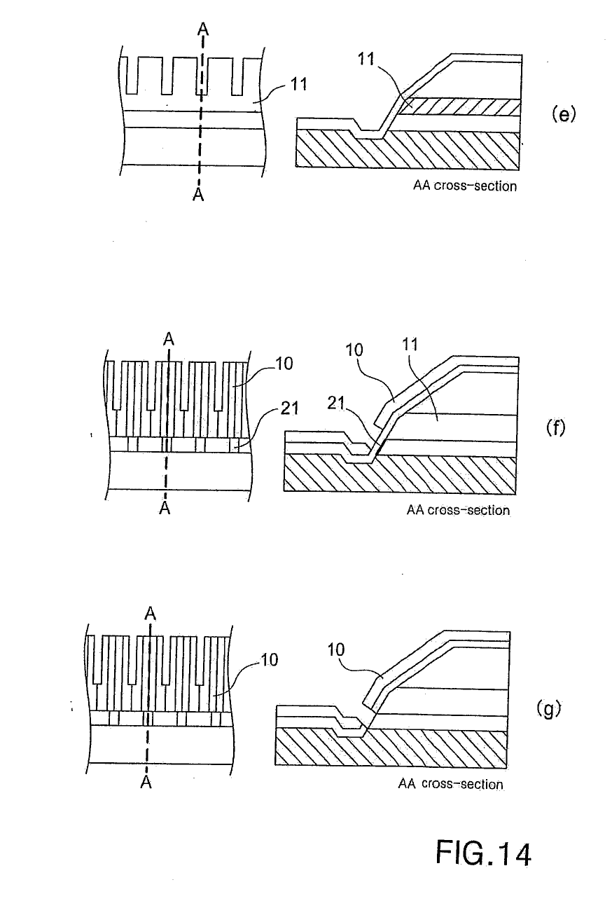

FIG. 14(e) shows a state in which metal film 11 was formed on the upper surfaces of the substrate and the surface of piezoelectric material 2 provided with grooves. The metal film 11 is formed by the electroless nickel plating on the surface of piezoelectric material 2 and the surface to which piezoelectric material 2 is adhered.

FIG. 14(f) shows Ni metal film 11. The metal film 11 was formed on the upper surfaces of the substrate and the surface of piezoelectric material 2 by the electroless nickel plating.

Resist 10 is formed on the film portion of metal film 11. At this time, a photosensitive resist is used. FIG. 14(f) shows a state in which only resist 10 of non-wiring part 22 on the adhesive 3 has been removed. FIG. 14(g) shows a state in which metal film 11 in the portion where resist 10 had been removed was removed by etching. FIG. 14(g) shows the non wiring part on the adhesive.

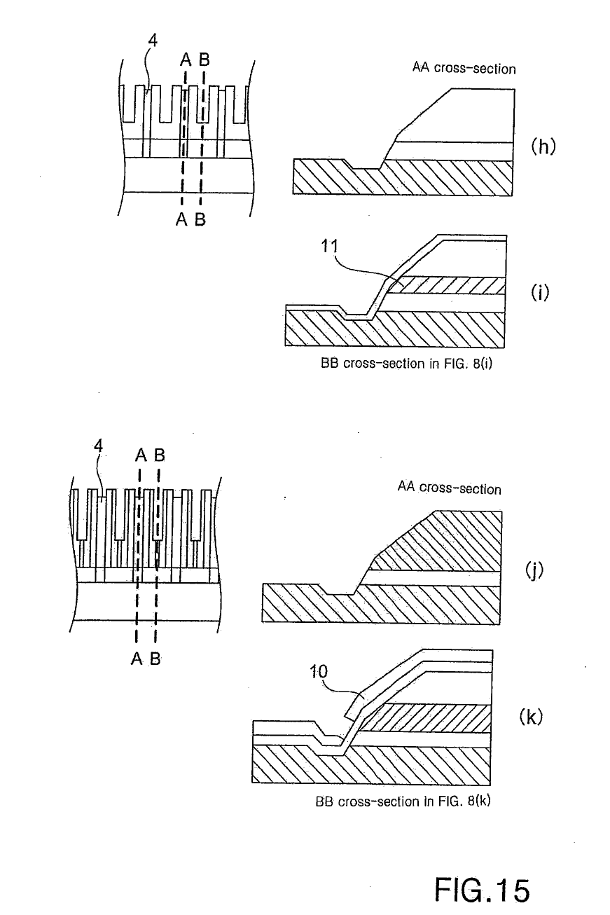

FIGS. 15(h) and 15(i) show a state in which resist 10 was removed.

FIGS. 15(j) and 15(k) show a state in which non-wiring part 22 was formed. The laser light is applied to the non-wiring part in the part excluding the adhesive portion and onto the top part of actuator 27 in the longitudinal direction except the non-wiring part on the adhesive part, slant 35, and substrate 26. The width of metal-film-removed-part 4 by laser light is 40 μm.

In the first through fourth embodiments, the method of forming the non-wiring part (the first non-wiring part) on substrate 26 and piezoelectric material 2 and the method of forming the non-wiring part (the second non-wiring part) on adhesive 3 are different. By removing the metal film and differentiating the first and second method of forming the respective non-wiring parts, the width of the non-wiring part on adhesive 3 and that of the non-wiring part on substrate 26 and piezoelectric material 2 can be equalized. Thus, the widths of pressure chamber 8 and wiring section 5 can be made uniformly. By making the widths of pressure chamber 8 and wiring section 5 be constant, the voltages applied to individual pressure chambers 8 become constant. As a result, The operational variation among individual actuators 27 can be reduced, and hence, variation in the quantity of ejected ink can be reduced.

According to the embodiments of the present application, the variation in the width of the wiring formed on the adhesive can be reduced. Therefore, this method is particularly beneficial to forming nozzles disposed in high density. This method of manufacturing an inkjet printhead uniforms the width of individual wirings and thereby reduces the variation in the wiring resistance. Moreover, by preventing possible disconnection of the wiring, sure operations of individual actuators can be attained.

This method of manufacturing an inkjet printhead is suitable to use when forming nozzles disposed in high density. In addition, because of reduced risk of disconnecting the wirings, the yield rate of the inkjet printhead can be improved.

While certain embodiments of the inventions have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

What is claimed is:

1. A method of manufacturing an inkjet printhead which comprises a substrate, actuators varying a volume of a pressure chamber, each actuator composing of a piezoelectric material, being adhered to the substrate and having an oblique angle at their ends in an ink flow direction within the pressure chamber, each actuator forming a sidewall that isolate the respective pressure chambers, an electrode composing of a metal film provided on the sidewall, a wiring part connected to the electrode, and a non-wiring part provided between the adjacent wiring parts, the method comprising:
adhering a substrate and an piezoelectric material together using an adhesive;
processing the piezoelectric material to form a groove therein;
forming a metal film on the sidewall and the substrate, the metal film as being the electrode and the wiring part;
forming a non-wiring part on the substrate and the piezoelectric material by a first processing method; and
forming a non-wiring part on the adhesive part by a second processing method different from the first processing method.

2. The method according to claim 1, wherein the first processing method is performed by laser processing.

3. The method according to claim 1, wherein the second processing method is performed by forming a pattern using a photosensitive resist.

4. The method according to claim 1, wherein the metal film is a nickel film formed on the surface of the piezoelectric material by an electroless nickel plating technique.

5. The method according to claim 1, wherein the adhesive is an epoxy adhesive.

6. The method according to claim 1, wherein the actuator is composed of two piezoelectric materials each of which is polarized in one direction opposing the other.

7. A method of manufacturing an inkjet printhead which comprises a substrate, actuators varying a volume of a pressure chamber, each actuator composing of a piezoelectric material, each actuator being adhered to the substrate and forming a sidewall that isolate the respective pressure chambers, an electrode composing of a metal film provided on the sidewall, a wiring part connected to the electrode, and a non-wiring part provided between the adjacent wiring parts, the method comprising:
adhering a substrate and an piezoelectric material together;
processing the piezoelectric material to form a groove therein;
forming a resist film on the adhesive between the substrate and the piezoelectric material, resist film forming the non-wiring part;
forming a metal film on the sidewall and substrate, the metal film as being the electrode and the wiring part;
forming the non-wiring part by laser processing excluding a portion formed by the resist film, and
removing the resist film.

8. The method according to claim 7, wherein the metal film is a nickel film formed on the surface of the piezoelectric material by the electroless nickel plating technique

9. The method according to claim 7, wherein the adhesive is an epoxy adhesive.

10. The method according to claim 7, wherein the actuator is composed of two piezoelectric materials each of which is polarized in one direction opposing the other.

11. An inkjet printhead, comprising:
a substrate;
actuators for varying a volume of a pressure chamber, each actuator having an obliquity angle at their ends in an ink flow direction within the pressure chamber and forming a sidewall that isolate the respective pressure chambers, and composing of a piezoelectric and forming sidewalls that isolate the respective pressure chambers;
an adhesive layer for fixing the actuators to the substrate;
an electrode composing of a metal film provided on the sidewall;
a wiring part composing of the metal film connected to the electrode;
a connecting part composed of the metal film, formed on the adhesive layer, for connecting the electrode and the wiring part;
a first non-wiring part provided between electrodes formed on the adjacent sidewalls and between the adjacent wiring parts; and
a second non-wiring part formed between the adjacent connecting parts in a method different from the method of forming the first non-wiring part.

12. The inkjet printhead according to claim 11, wherein the first non-wiring part is formed by laser processing, and the second non-wiring part is formed by etching technique.

13. The inkjet printhead according to claim 11, wherein the metal film is a nickel film formed on the surface of the piezoelectric material by the electroless nickel plating technique.

14. The inkjet printhead according to claim 11, wherein the adhesive is an epoxy adhesive.

15. The inkjet printhead according to claim 11, wherein the actuator is composed of two piezoelectric materials each of which is polarized in one direction opposing the other.
